(19) United States
(12) Patent Application Publication
(10) Pub. No.: US 2025/0052448 A1
(43) Pub. Date: Feb. 13, 2025

(54) CONDENSATE MANAGEMENT SYSTEMS AND METHODS

(71) Applicant: Rheem Manufacturing Company, Atlanta, GA (US)

(72) Inventors: Saman Beyhaghi, Opelika, AL (US); Shubham Srivastava, Suwanee, GA (US); Bruce Andrew Hotton, Cranberry Township, PA (US); Grady Britton, Montgomery, AL (US); Christopher James Lloyd, Montgomery, AL (US); Juan Francisco Caretta Garcia, Nuevo Laredo (MX); Benjamin Jordan Shewmake, Birmingham, AL (US); Ashwin Vishwanath Rao, Montgomery, AL (US); Daniel Alexis Reyes Espinoza, Nuevo Laredo (MX); Marco Antonio Lopez Villagran, Nuevo Laredo (MX); David Isai Vega Fernandez, Montgomery, AL (US); Vishwanath Reddy Ardha, Cumming, GA (US)

(21) Appl. No.: 18/779,376

(22) Filed: Jul. 22, 2024

Related U.S. Application Data
(60) Provisional application No. 63/518,401, filed on Aug. 9, 2023.

(51) Int. Cl. F24H 8/00; B01D 45/02; C02F 1/66; F24H 1/00

(52) U.S. Cl. CPC F24H 8/006; B01D 45/02; C02F 1/66; F24H 1/0027; C02F 2201/006; C02F 2209/06

(57) ABSTRACT

A system for use with a fuel-burning water heater and a ventilation conduit is disclosed. The fuel-burning water heater is configured to burn fuel and generate gaseous exhaust and condensate from the burning of the fuel. The ventilation conduit is configured to remove the gaseous exhaust from the fuel-burning water heater. The system includes an input port configured to receive the gaseous exhaust and the condensate, a neutralizing material holder configured to house a condensate neutralizing material therein and to receive the condensate from the input port, a gas output port configured to provide the gaseous exhaust to the ventilation conduit, and a liquid output port configured to output condensate from the neutralizing material holder. The neutralizing material holder is disposed between the input port and the liquid output port.

### CROSS-REFERENCE TO RELATED APPLICATIONS

This application claims priority to and the benefit of U.S. provisional application No. 63/518,401, filed Aug. 9, 2023, which is hereby incorporated by reference in its entirety.

### FIELD

This disclosure relates generally to water heaters and more particularly to systems and methods for managing condensate in water heaters.

### BACKGROUND

FIG. 1A illustrates a typical water heater system 100 at a time t₀. The water heater system 100 includes a water tank 102, a heating system 104 that includes a burner and heat exchanging coil, a fuel line 106, a water input line 108, a hot water output line 110, a main exhaust ventilation conduit 112, an output line 114, a secondary exhaust ventilation conduit 116, a condensate neutralizing catch 126, and a condensate output 128. The secondary exhaust ventilation conduit 116 includes a T-connector 118, a conduit 117, a T-connector 120, a conduit 122, and a cap 124. The T-connector 118 has an input port 130, a ventilation output port 132, and a condensate output port 134. The input port 130 is configured to connect to the output line 114. The ventilation output port 132 is configured to connect to the conduit 117. The condensate output port 134 is configured to connect to the condensate neutralizing catch 126. The T-connector 120 has a ventilation input port 136, a ventilation output port 138, and a neutralizer receiving port 140. The ventilation input port 136 is configured to connect to the conduit 117. The ventilation output port 138 is configured to connect to the conduit 122. The neutralizer receiving port 140 is configured to connect to the cap 124. The T-connector 123 connects the conduit 122 to the main exhaust ventilation conduit 112.

In operation, the fuel line 106 provides fuel, such as natural gas, propane, oil, hydrogen, etc. to the heating system 104. The burner within the heating system ignites the fuel to generate heat, which is provided to a heat exchanging coil. The heat exchanging coil transfers the heat from the burned fuel to water within the water tank 102 to heat the water. Hot water is delivered via the hot water output line 110. As hot water is output from the water tank 102, cold water refills the water tank 102 as needed via the water input line 108. The water supplied by the water input line 108 is typically cool and needs to be heated. As such, the heating system 104 again burns fuel to generate heat, which is transferred to the cool water via the heat exchange coil.

When the heating system burns fuel, the exhaust gases are vented via the main exhaust ventilation conduit 112. In some instances, some exhaust fumes are also output via the output line 114. These exhaust fumes pass into the T-connector 118, through the conduit 117, through the T-connector 120, through the conduit 122, and are exhausted via the main exhaust ventilation conduit 112.

The exhaust gases may include condensate. In this manner, the exhaust gases and condensate pass into the T-connector 118. As noted above, the exhaust gasses travel upward through the secondary exhaust ventilation conduit 116. In contrast, the condensate drops as a result of gravity into the condensate neutralizing catch 126, where it is output via the condensate output 128. Typically, an output line or some type of pumping system is connected to the condensate output 128 so as to provide the condensate to a drain or the like.

In some instances, the condensate from the condensate output port 134 may be acidic. Directly releasing such acidic condensate to the drain is not ideal. For this reason, the condensate may be neutralized prior to being output to the drain. This is the function of the condensate neutralizing catch 126. In particular, a neutralizing material, such as calcium carbonate, calcium hydroxide, magnesium hydroxide, and combinations thereof, in the form of rocks or pellets, may be deposited within the condensate neutralizing catch 126. The neutralizing material may be any suitable material. For example, as the acidic condensate drips into the condensate neutralizing catch 126, the calcium carbonate reacts with the acidic fluid, thereby creating a form of salt water with a more neutral pH. This neutralized fluid is then output by the condensate output 128.

The neutralizing material is eventually depleted and replaced. For example, FIG. 1B illustrates the water heater system 100 at a time t₁. Here, the cap 124 is removed or flipped up to reveal the neutralizer receiving port 140. The user may then deposit rocks or pellets of neutralizer into the neutralizer receiving port 140. The deposited neutralizer rocks or pellets fall down and rest in the condensate neutralizing catch 126. A problem with the water heater system 100 is that a user cannot easily determine how much neutralizing rocks or pellets are present in the condensate neutralizing catch 126 at any particular time. In fact, there may be instances where the neutralizing rocks or pellets are totally depleted for a matter of time before the user decides to check on the status. In such cases, acidic condensate is undesirably output to the drain, which may have detrimental effects.

### BRIEF DESCRIPTION OF THE DRAWINGS

The detailed description is set forth with reference to the accompanying drawings. In some instances, the use of the same reference numerals may indicate similar or identical items. Various embodiments may utilize elements and/or components other than those illustrated in the drawings, and some elements and/or components may not be present in various embodiments. Throughout this disclosure, depending on the context, singular and plural terminology may be used interchangeably.

FIG. 1A illustrates a prior art water heater system at a time t₀.

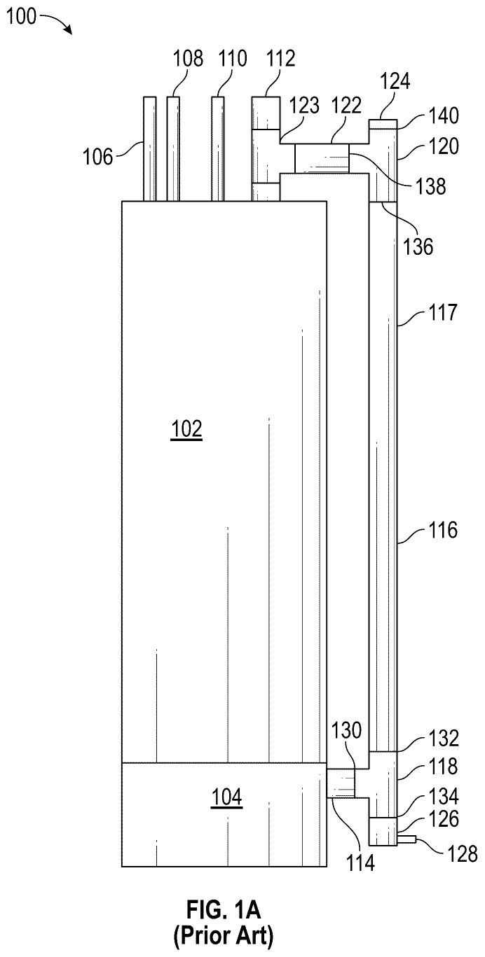

FIG. 1B illustrates the prior art water heater system of FIG. 1A at a time t₁.

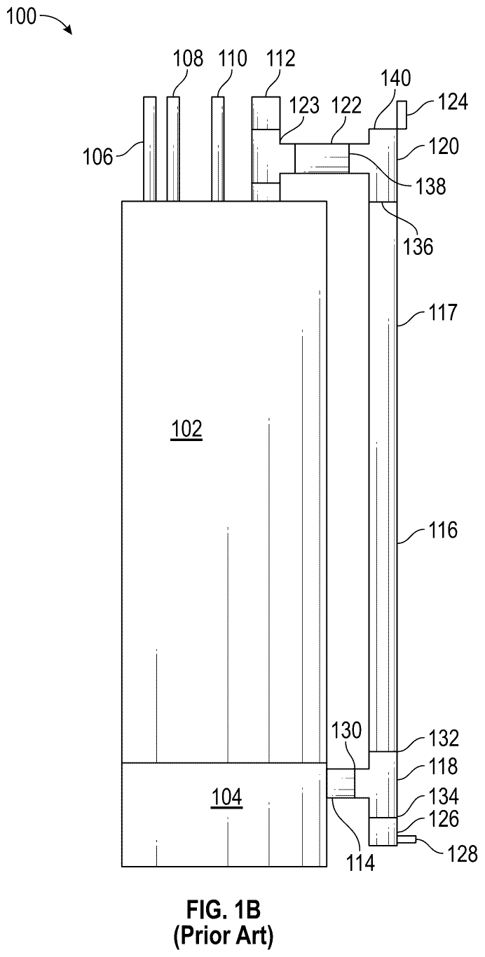

FIG. 2 illustrates a water heater system in accordance with one or more embodiments of the present disclosure.

FIG. 3A illustrates an exploded view of a condensate management system in accordance with one or more embodiments of the present disclosure.

FIG. 3B illustrates a perspective view of the condensate management system of FIG. 3A in accordance with one or more embodiments of the present disclosure.

FIG. 4 illustrates a perspective view of a condensate management system in accordance with one or more embodiments of the present disclosure.

FIG. 5 illustrates a cross-sectional view of the condensate management system of FIG. 4 in accordance with one or more embodiments of the present disclosure.

FIG. 6 illustrates a plan view of the condensate management system of FIG. 4 in accordance with one or more embodiments of the present disclosure.

FIG. 7 illustrates a cross-sectional view of the condensate management system of FIG. 4 with a neutralizing material level detection system in accordance with one or more embodiments of the present disclosure.

FIG. 8 illustrates a method of operating the condensate management system of FIG. 4 in accordance with one or more embodiments of the present disclosure.

FIG. 9 illustrates a block diagram of the controller of the condensate management system of FIG. 4 in accordance with one or more embodiments of the present disclosure.

FIG. 10A illustrates water heating system with another condensate management system in accordance with one or more embodiments of the present disclosure.

FIG. 10B is a side view of the condensate management system of FIG. 10A in accordance with one or more embodiments of the present disclosure.

FIG. 10C is a top right side perspective view of a portion of the condensate management system of FIG. 10A in accordance with one or more embodiments of the present disclosure.

FIG. 10D is a top left side perspective view of a portion of the condensate management system of FIG. 10A in accordance with one or more embodiments of the present disclosure.

FIG. 11 illustrates a cross-sectional perspective view of a cartridge for holding a neutralizing material in accordance with one or more embodiments of the present disclosure.

FIG. 12 illustrates a cross-sectional view of a portion of a water heating system in accordance with one or more embodiments of the present disclosure.

FIG. 13A illustrates a side view of the condensate management system of FIG. 10A with neutralizing material disposed therein in accordance with one or more embodiments of the present disclosure.

FIG. 13B illustrates a side view of the condensate management system of FIG. 10A without neutralizing material disposed therein in accordance with one or more embodiments of the present disclosure.

FIG. 13C illustrates a side view of the condensate management system of FIG. 10A with a blockage in accordance with one or more embodiments of the present disclosure.

FIG. 14 illustrates a method of operating the condensate management system of FIG. 10A in accordance with one or more embodiments of the present disclosure.

FIG. 15A illustrates a controller of the condensate management system of FIG. 10A at a time 12 in accordance with one or more embodiments of the present disclosure.

FIG. 15B illustrates the controller of FIG. 15A, at a time t₃ in accordance with one or more embodiments of the present disclosure.

### DETAILED DESCRIPTION

This disclosure relates generally to fuel-burning water heaters having a condensate neutralizing system that is configured to receive condensate from the water heater, to neutralize the condensate with a condensate neutralizing material, and to output the neutralized condensate to a drain or the like. The systems and methods disclosed herein may be implemented in tank or tankless water heaters.

In certain embodiments, the condensate neutralizing system includes a condensate neutralizing holder that is configured to hold condensate neutralizing material between two mesh screens. The condensate neutralizing holder is positioned to receive condensate from the fuel-burning water heater, pass the condensate through condensate neutralizing material, and output the neutralized condensate. Further, the neutralizing holder may be easily detachable from the fuel-burning water heater so that a user can easily determine how much condensate neutralizing material remains and replace the condensate neutralizing material if needed.

In certain embodiments, the condensate neutralizing system includes a neutralizing material holder that holds the condensate neutralizing material. The condensate neutralizing system also includes an access port that provides access to the neutralizing material holder. Further, the access port is covered by a moveable panel such that a user can open the panel to easily replace the condensate neutralizing material if needed.

In certain embodiments, the condensate neutralizing system includes a neutralizing material holder that holds the condensate neutralizing material as a single slab of material. In some instances, the slab of condensate neutralizing material includes grooves to increase the surface area for which the condensate can react.

In certain embodiments, the condensate neutralizing system includes a magnet and a Hall sensor. The magnet is configured to rest on the condensate neutralizing material within a neutralizing material holder. The Hall sensor is configured to detect the magnetic field from the magnet. In these embodiments, as the condensate neutralizing material depletes, the magnet draws closer to the Hall sensor. Eventually, the Hall sensor is configured to detect when the magnet is so close that the neutralizing material should be replaced. The condensate neutralizing system is therefore able to inform a user that the condensate neutralizing material should be replaced. The warning may take the form of a localized audible/visual alarm of the condensate neutralizing system, a display of the condensate neutralizing system, a wireless communication from the condensate neutralizing system and to a device of the user, such as smartphone, a communication to a desktop of the user, or combinations thereof.

In certain embodiments, the condensate neutralizing system includes a water sensor and a pH sensor. If the water sensor senses water, then the condensate neutralizing system may provide a warning to a user that the condensate neutralizing system is clogged. If the pH sensor senses that the pH of the outgoing condensate is outside of a predetermined range (e.g., too low, which may indicate the condensate is too acidic), then the condensate neutralizing system may provide a warning to a user that the condensate neutralizing system needs more condensate neutralizing material.

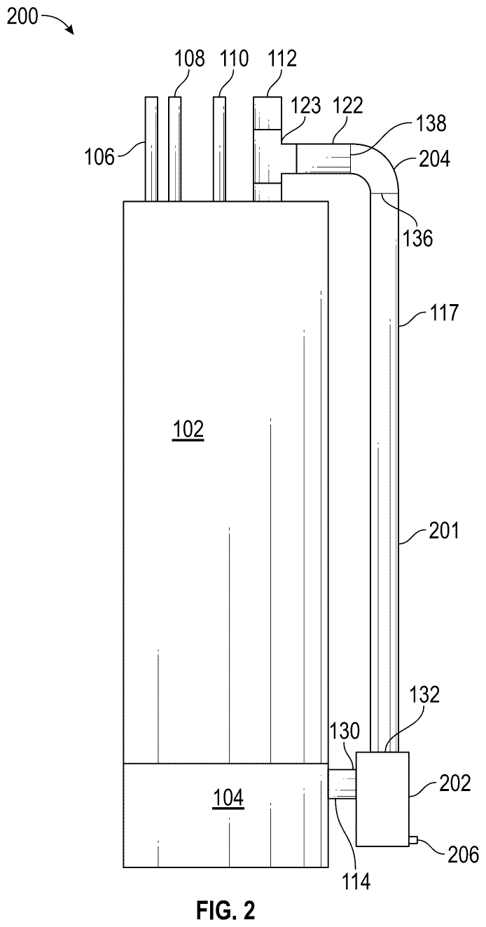

Turning now to the drawings, FIG. 2 illustrates a water heater system 200 in accordance with one or more embodiments of the present disclosure. The water heater system 200 includes the water tank 102, the heating system 104 that includes a burner and heat exchanging coil, the fuel line 106, the water input line 108, the hot water output line 110, the main exhaust ventilation conduit 112, the output line 114, a secondary exhaust ventilation conduit 201, a condensate management system 202, and a condensate output 206. The secondary exhaust ventilation conduit 201 includes the conduit 117, an elbow connector 204, and the conduit 122. In some instances, the water tank 102 may be omitted and the system may be a tankless water heater.

The water heater system 200 differs from the water heater system 100 discussed above in that the water heater system 200 does not include the T-connector 120 and the cap 124. Further, the water heater system 200 replaces the T-connector 118 and the condensate neutralizing catch 126 of the water heater system 100 with the condensate neutralizing system 200. In particular, in accordance with one or more embodiments of the present disclosure, the condensate management system 202 enables a user to easily determine whether condensate neutralizing material is present or needs to be added to the condensate management system 200.

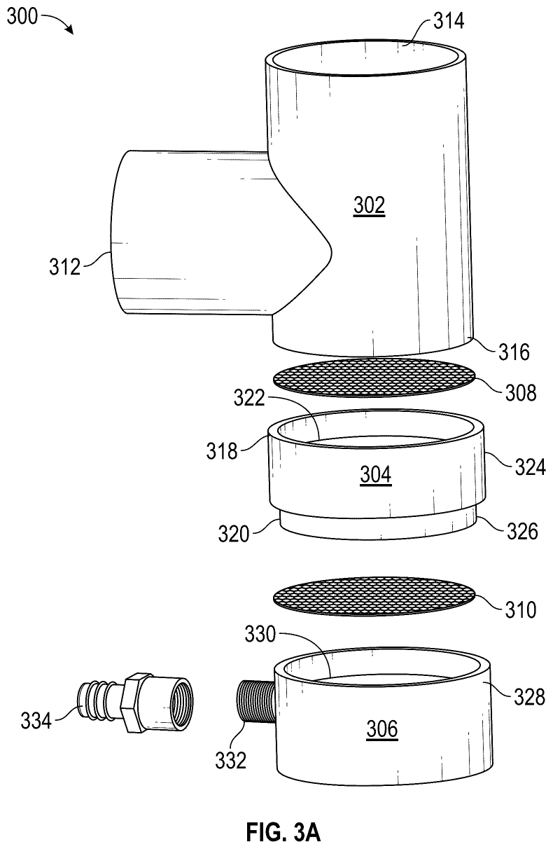

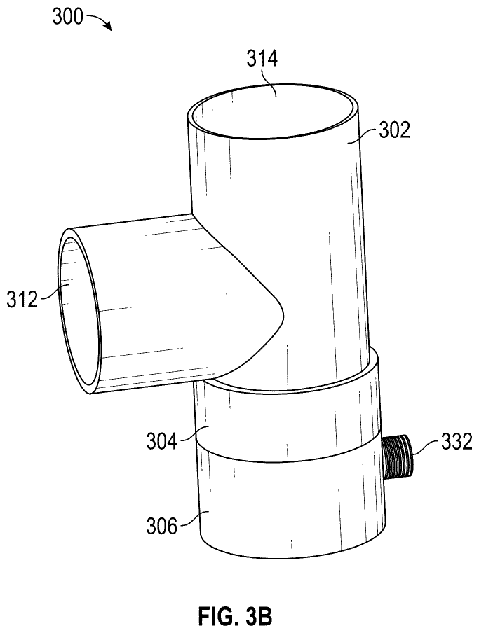

FIG. 3A illustrates an exploded view of a condensate management system 300 in accordance with one or more embodiments of the present disclosure. The condensate management system 300 corresponds to one or more embodiments of the condensate management system 202 of FIG. 2. The condensate management system 300 includes a T-connector 302, a condensate neutralizing material holder 304, a condensate trap 306, a mesh screen 308, and a mesh screen 310. As used herein, a “mesh screen” may be any material with pores, apertures, etc., that allows flow of liquid therethrough but stops certain sized solids from passing therethrough.

The T-connector 302 includes an input port 312, a ventilation output port 314, and a condensate output port 316. The input port 312 is configured to connect to the output line 114. The ventilation output port 314 is configured to connect to the conduit 117 or the like. The condensate output port 316 is configured to connect to the condensate neutralizing material holder 304.

The condensate neutralizing material holder 304 includes an input port 318 and an output port 320. An interior concentric ledge 322 is configured to receive the mesh screen 308. Further, the input port 318 is configured to receive the output port 316 of the T-connector 302 such that the output port 316 rests on the mesh screen 308, which rests on the interior concentric ledge 322. In this manner, the mesh screen 308 is sandwiched between the output port 316 and the interior concentric ledge 322. In some instances, the outer wall 324 of the condensate neutralizing material holder 304 has a circumference that matches that of the T-connector 302. The condensate neutralizing material holder 304 additionally includes a male circumferential ring 326 at the output port 320 that has a circumference that is smaller than that of the circumference of the outer wall 324.

The condensate trap 306 includes an input port 328 and an interior concentric ledge 330. The interior concentric ledge 330 is configured to receive the mesh screen 310 and the male circumferential ring 326 such that the male circumferential ring 326 rests on the mesh screen 310, which rests on the interior concentric ledge 330. In this manner, the mesh screen 310 is sandwiched between the male circumferential ring 326 and the interior concentric ledge 330. The condensate trap 306 additionally includes a condensate output 332. An optional adaptor 334 may be included to connect the condensate output 332 to an output hose having a diameter that does not connect to the condensate output 332.

The condensate neutralizing material holder 304 may be pulled away from the T-connector 302 and the mesh screen 308 may be lifted out of the condensate neutralizing material holder 304. In this manner, a user may easily disconnect the condensate neutralizing material holder 304 to determine whether condensate neutralizing material needs to be added between the mesh screen 308 and the mesh screen 310. If so, the user may add condensate neutralizing material into the condensate neutralizing material holder 304 so as to rest on the mesh screen 310. Once the condensate neutralizing material is resupplied to the condensate neutralizing material holder 304, the mesh screen 308 may be replaced. At that point, the replenished neutralizing material holder 304 may be re-connected to the T-connector 302.

FIG. 3B illustrates a perspective view of the condensate management system 300. In operation, condensate and exhaust fumes from the output line 114 enter the input port 312. The condensate falls, due to gravity, passes through the mesh screen 308, passes over the condensate neutralizing material within the condensate neutralizing material holder 304, passes through the mesh screen 310, falls into the condensate trap 306, and eventually passes out through the condensate output 332, which may be connected to drain or the like.

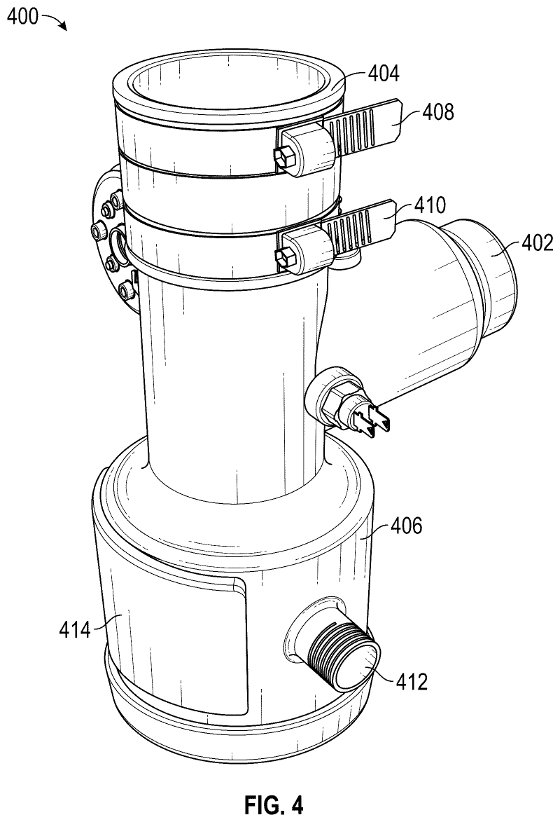

FIG. 4 illustrates a perspective view of a condensate management system 400 in accordance with one or more embodiments of the present disclosure. The condensate management system 400 corresponds to one or more embodiments of the condensate management system 202 of FIG. 2. The condensate management system 400 includes an input port 402, a ventilation output port 404, a condensate neutralization material holding portion 406, pipe clamps 408 and 410, a condensate output 412, and a moveable panel 414. The input port 402 is configured to connect to the output line 114. The ventilation output port 404 is configured to connect to the conduit 117 or the like. The pipe clamps 408 and 410 enable easy connection/disconnection between the ventilation output port 404 and the conduit 117.

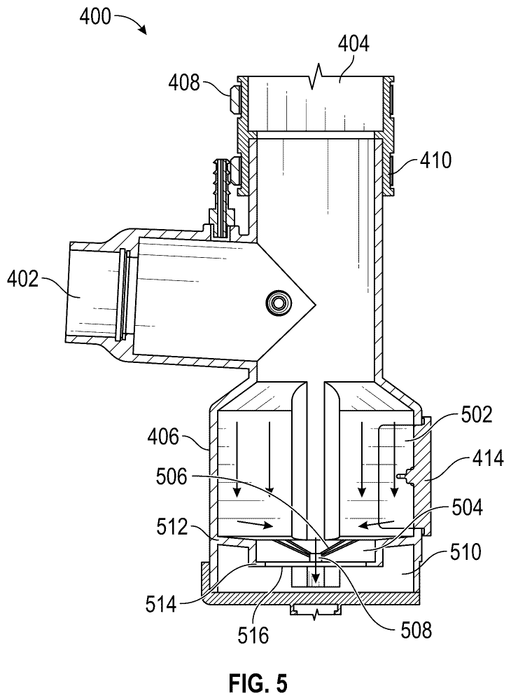

FIG. 5 illustrates a cross-sectional view of the condensate management system 400. When condensate enters the input port 402, it falls due to gravity into the condensate neutralization material holding portion 406, as shown by arrows 502. In this example, the condensate neutralization material is not in the form of a plurality of loose pellets or rocks. Rather, in accordance with one or more embodiments of the present disclosure, the condensate neutralization material is a single slab 504 of condensate neutralization material. The slab 504 of condensate neutralization material is configured to have a centrally sloping top surface 506 with centrally located hole 508. That is, the top surface 506 slops towards the centrally located hole 508. In this manner, when the condensate falls onto the centrally sloping top surface 506, the condensate runs along the centrally sloping top surface 506 until it eventually falls through the centrally located hole 508. After passing through the centrally located hole 508, the condensate passes into a catch area 510. Once in the catch area 510, the neutralized condensate is output through the condensate output 412.

The condensate neutralization material holding portion 406 includes a top portion and a bottom portion, which are separated by a slopped inner ring 512 that includes a centrally located recessed lip 514 that is configured to hold the slab 504. The centrally located recessed lip 514 has a central opening 516 configured to enable the centrally located hole 508 of the slab 504 to expand as the condensate neutralization material of the slab 504 depletes.

The movable panel 414 covers a neutralizing material holder access port 518 configured to enable placement of the slab 504 into the neutralizing material holding portion 406. The moveable panel 414 is configured to be in an opened state or a closed state. In the opened state, the moveable panel 414 is configured to provide access to the neutralizing material holder access port 518. For example, a user may replace the slab 504 through the access port 518 when the movable panel 414 is in the opened state. In the closed state, the moveable panel 414 is configured to cover the neutralizing material holder access port 518.

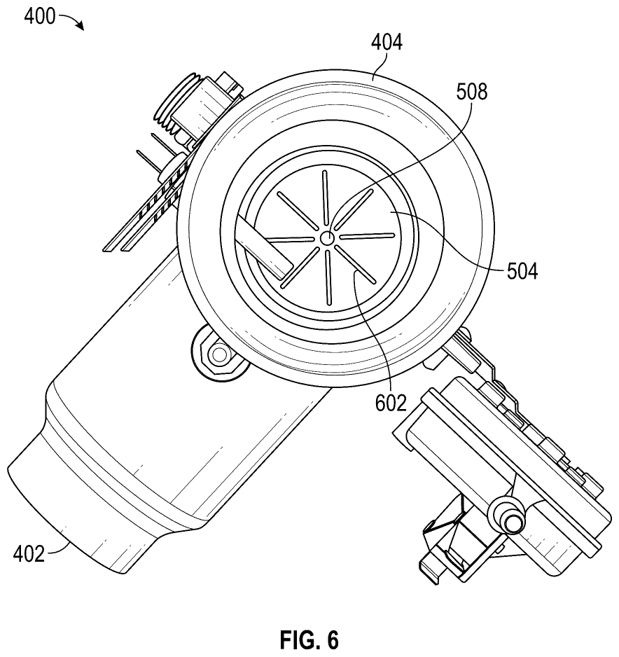

FIG. 6 illustrates a plan view of the condensate management system 400. In certain instances, the slab 504 may include one or more grooves 602 within the centrally sloping top surface 506 thereof. The grooves 602 are configured to increase the surface area for which a drop of condensate touches the slab 504 so as to increase the time for neutralization of the acidity of the condensate. It should be noted that grooves 602 may be straight, curved, or spiraled to increase the time for neutralization. In some instances, the groves extend radially from the centrally located hole 508.

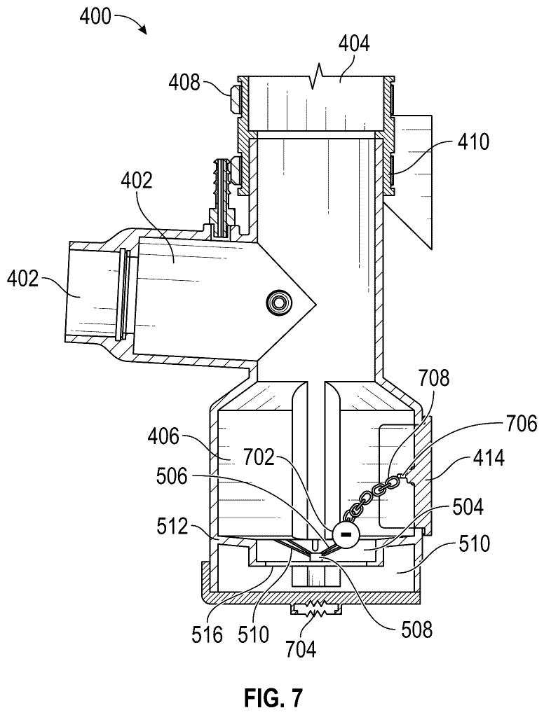

FIG. 7 illustrates a cross-sectional view of the condensate management system 400 with a neutralizing material level detection system in accordance with one or more embodiments of the present disclosure. In certain embodiments, the condensate management system 400 may additionally include a magnet 702, a Hall sensor 704, and a tether 708. The Hall sensor 704 is configured to detect a magnetic field from the magnet 702 and to output a Hall sensor signal based on the detected magnetic field. The tether 708 may be any known type of chain, rope, or the like that is configured to connect to the magnet 506 and to the movable panel 414.

In operation, when the movable panel 414 is in a closed state, the tether 708 is configured to enable the magnet to rest on the slab 504. Gravity draws the magnet 702 toward the center of the slab 504 as a result of the centrally sloping top surface 506 of the slab 504. The Hall sensor 704 will detect the magnetic field, B_{det}, of the magnet 702.

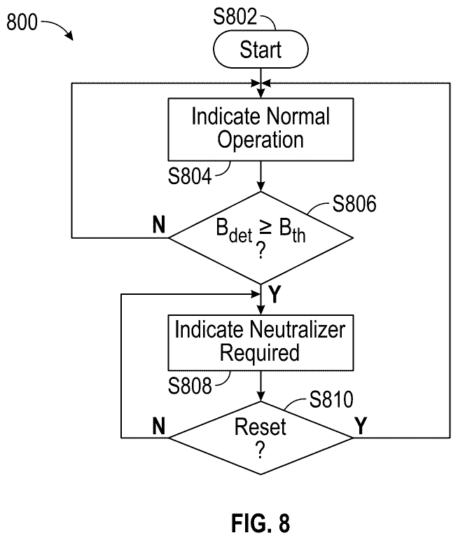

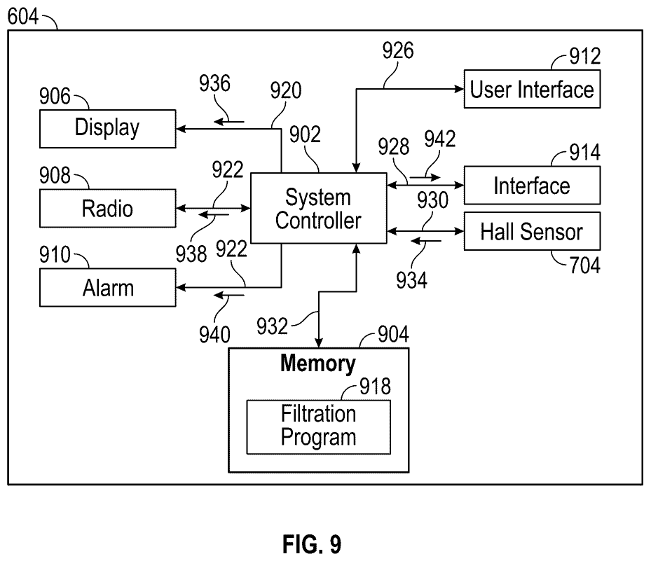

The magnetic field may change as the slab 504 is depleted and the magnet 702 moves closer to the Hall sensor 704. For example, FIG. 8 illustrates a method 800 of operating the condensate management system of 400 in accordance with one or more embodiments of the present disclosure. The method 800 starts (S802), and normal operation is indicated (S804). This will be described in greater detail with reference to FIG. 9.

FIG. 9 illustrates a block diagram of the controller 604 of the condensate management system 400 in accordance with one or more embodiments of the present disclosure. The controller 604 includes a system controller 902, a memory 904, a display 906, a radio 908, an alarm 910, a user interface 912, an interface 914, and a Hall sensor 704. The memory 904 has data and instructions stored therein, including filtration program 918.

The system controller 902 is configured to communicate with the display 906 via a communication channel 920, the radio 908 via a communication channel 922, the alarm 910 via a communication channel 924, the user interface 912 via a communication channel 926, the interface 914 via a communication channel 928, the Hall sensor 704 via a communication channel 930, and the memory 904 via a communication channel 932.

In this example, the system controller 902, the memory 904, the display 906, the radio 908, the alarm 910, the user interface 912, the interface 914, and the Hall sensor 704 are illustrated as individual devices. However, in some embodiments, at least two of the system controller 902, the memory 904, the display 906, the radio 908, the alarm 910, the user interface 912, the interface 914, and the Hall sensor 704 may be combined as a unitary device.

The system controller 902 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of the controller 604 in accordance with the embodiments described in the present disclosure. Any suitable computing device may be used herein. The memory 904 may have instructions, including the filtration program 918, stored therein to be executed by the system controller 902, causing the controller 602 to provide a low neutralizing material indication based on a signal from the Hall sensor 704. In some instances, the low neutralizing material indication may be a wired or wirelessly signal.

The display 906 may be any known device or system that is configured to display information related to the controller 602 to a user. The radio 908 may include an interface radio transceiver that is configured to communicate with a network. The alarm 910 may be any known device or system that is configured to provide a localized warning in the form of an audible indication, a visual indication, and combinations thereof. In some instances, the audible indication may take the form of a constant tone, a periodic beep, or the like. In some instances, the visual indication may take the form of a constantly lighted diode, a blinking diode, or the like. The user interface 912 may be any known device or system to enable a user to interact with the controller 604. The interface 914 can include one or more connectors to enable wired or wireless communication with external devices or networks.

In certain instances, the system controller 902 may execute instructions in the filtration program 918 to cause the display 906 to indicate that the condensate management system 400 is operating normally as a default. Such indication may take the form of an LED, a graphic user interface that explicitly displays words such as “Normal Operation,” a graphic user interface that illustrates some icon that corresponds to normal operation, or the like.

Returning to FIG. 8, after an indication of normal operation (S804), it is determined whether the detected magnetic field, B_{det}, is greater than or equal to a predetermined threshold magnetic field, Bₜₕ (S806). For example, as shown in FIG. 7, the Hall sensor 704 detects the magnetic field, B_{det}, of magnet 702. As shown in FIG. 9, in one or more embodiments, the Hall sensor 704 sends a Hall sensor signal 934 based on the B_{det} to the system controller 902 via the communication channel 930. The memory 904 may have a threshold value of the magnetic field, Bₜₕ, stored therein. Upon receiving Hall sensor signal 934, the system controller 902 may execute instructions in the filtration program 918 to obtain the value of Bₜₕ from the memory 904 and determine whether B_{det}≥Bₜₕ. If B_{det}≥Bₜₕ, this would indicate that the magnet 702 is within a certain distance (e.g., close) to the Hall sensor 704, which in turn would indicate that the slab 504 has deteriorated to a point that it should be replaced. On the other hand, if B_{det}<Bₜₕ, this would indicate that the magnet 702 is outside a certain distance (e.g., not close) to the Hall sensor 704, which in turn would indicate that the slab 504 has not yet deteriorated to a point that it should be replaced.

Returning to FIG. 8, if it is determined that B_{det} is not greater than or equal to Bₜₕ, (N at S806), then an indication of normal operation remains (return to S804). Alternatively, if it is determined that B_{det} is greater than or equal to Bₜₕ, (Y at S806), then an indication is provided that condensate neutralizer material is required (S808). For example, as shown in FIG. 9, in one or more embodiments, the system controller 902 may execute instructions in the filtration program 918 to cause the controller 902 to transmit a display instruction 936 to the display 906 via the communication channel 920. The display instruction 936 may instruct the display 906 to indicate that condensate neutralization material needs to be added to the condensate management system 400. Such indication may take the form of an LED that is different from the LED for normal operation as discussed above, a graphic user interface that explicitly displays words such as “Neutralization Material Needed,” a graphic user interface that illustrates some icon that corresponds to neutralization material being needed, or the like.

In one or more embodiments, the system controller 902 may execute instructions in the filtration program 918 to cause the controller 902 to transmit an instruction 938 to the radio 908 via the communication channel 922. The instruction 938 may cause the radio 908 to wirelessly communicate with an associated device, such as a smartphone or tablet of the user. The wireless communication may be performed by any known wireless communication standard. The communication from the radio 908 may indicate that condensate neutralization material needs to be added to the condensate management system 400.

In one or more embodiments, the system controller 902 may execute instructions in the filtration program 918 to cause the controller 902 to transmit an alarm instruction 940 to the alarm 910 via the communication channel 924. The alarm instruction 940 may cause the alarm 910 to provide a localized warning in the form of an audible indication, a visual indication, or combinations thereof.

In one or more embodiments, the system controller 902 may execute instructions in the filtration program 918 to cause the controller 902 to transmit a network instruction 942 to the interface 914 via the communication channel 928. The network instruction 942 may cause the interface 914 to communicate with a network device of the user, such as a desk-top computer. The communication may be performed by any known communication standard. The communication from the interface 914 would indicate that condensate neutralization material needs to be added to the condensate management system 400.

When a user is notified that condensate neutralization material is needed, by any of the display 906, the radio 908, the alarm 910, the interface 914, or combinations thereof, the user may replace the condensate neutralization material. For example, as shown in FIG. 5, the user may open the moveable panel 414, remove any remaining portions of the slab 504, which has been too depleted for further use, and may insert a new slab 504.

Returning to FIG. 8, after an indication is provided that neutralizer material is required (S808), it is determined whether the system has been reset (S810). For example, as shown in FIG. 9, the user interface 912 may have a “reset” interface, such as a button, to reset the condensate management system 400. The system controller 902 may execute instructions in the filtration program 918 to cause the system controller 902 to determine whether a reset instruction has been entered by the user via the user interface 912. Returning to FIG. 8, if it is determined that the system has not been reset (N at S810), then the indication that neutralizer material is required remains (return to S808). Alternatively, if it is determined that the system has been reset (Y at S810), then an indication of normal operation is again provided (return to S804).

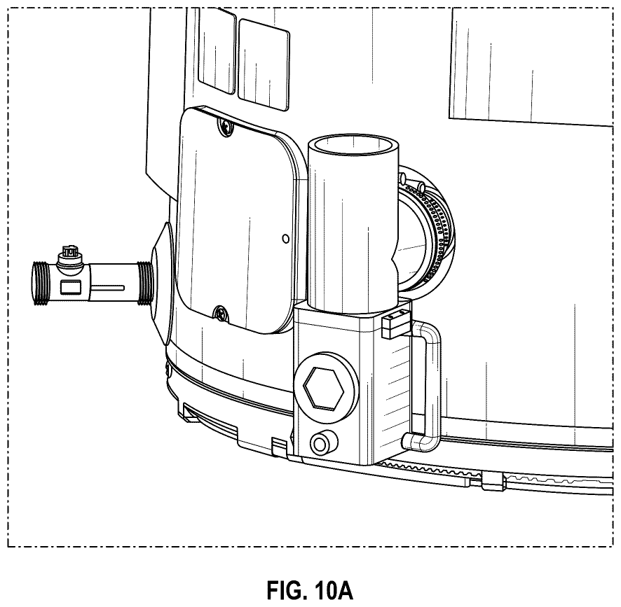

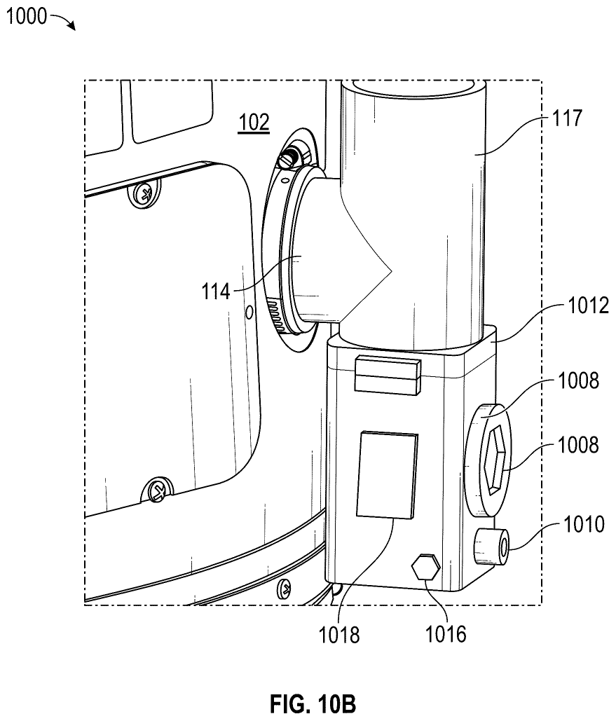

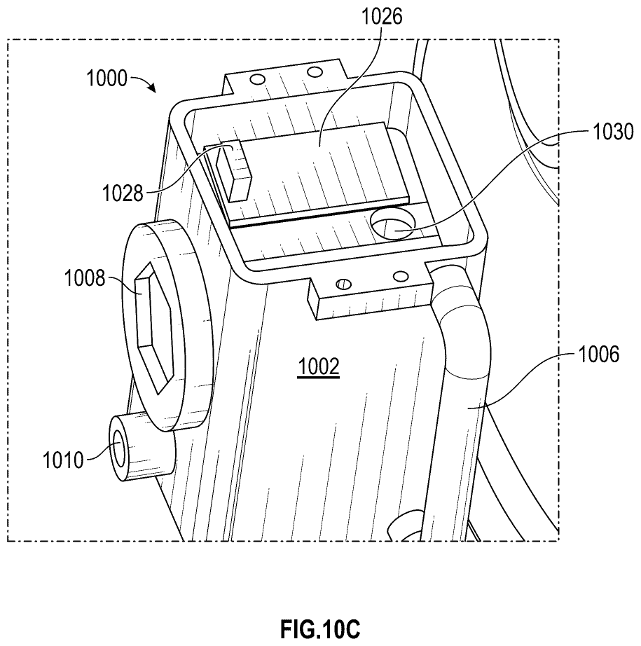

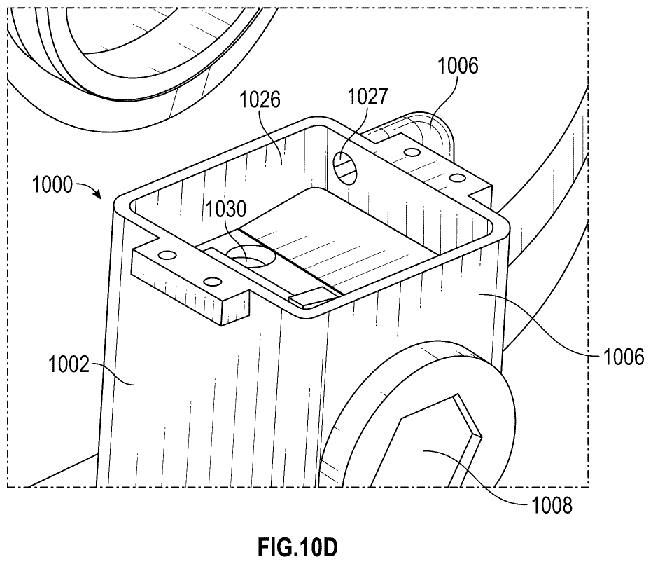

FIG. 10A illustrates the water heating system with a condensate management system 1000 in accordance with one or more embodiments of the present disclosure. The condensate management system 1000 corresponds to one or more embodiments of the condensate management system 202 of FIG. 2. The condensate management system 1000 includes a condensate neutralization material holding portion 1002, a neutralizing material holder access port 1004, overflow tubing 1006, a cartridge 1008, a condensate output 1010, and a cap 1012. The cap 1012 is configured to connect to the conduit 117. FIG. 10B is a side view of the condensate management system of FIG. 10A. As shown in FIG. 10B, the condensate management system 1000 additionally includes a pH detector 1016 and a controller 1018. FIG. 10C is a top right side perspective view of a portion of the condensate management system 1000 with the cap 1012 removed. With the cap removed, the condensate neutralization material holding portion 1002 includes an overflow space 1026 having a water detector 1028 and a condensate passthrough 1030 therein. FIG. 10D is a top left side perspective view of a portion of the condensate management system 1000 with the cap 1012 removed. The overflow space 1026 additionally has an overflow port 1027 for the overflow tubing 1006.

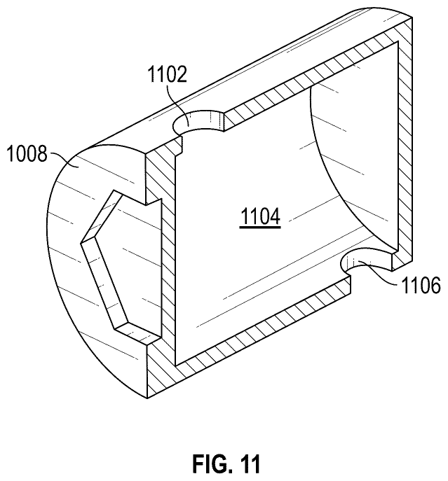

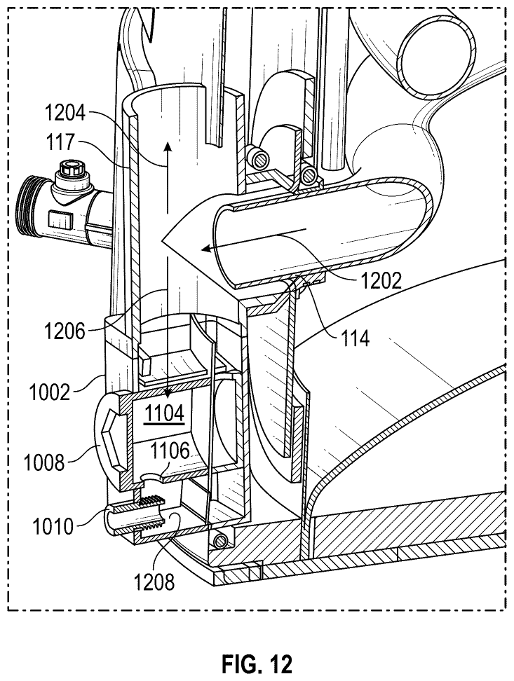

FIG. 11 illustrates a cross-sectional perspective view of the cartridge 1008 in accordance with one or more embodiments of the present disclosure. The cartridge 1008 includes a condensate input port 1102 and a condensate output port 1106. A space 1004 within the cartridge is configured to house condensate neutralization material, either rocks, pellets, or a single slab. Any suitable condensate neutralization material may be used. FIG. 12 illustrates a cross-sectional view of a portion of the water heating system of FIG. 10A in accordance with one or more embodiments of the present disclosure.

During operation, condensate and exhaust fumes pass from the output line 114, as indicated by arrow 1202. The exhaust fumes exit up through the conduit 117, as indicated by the arrow 1204. Returning to FIG. 10C, the condensate flows through the condensate passthrough 1030. Returning to FIG. 11, the condensate then flows through the condensate input port 1102, through the condensate neutralization material stored within the space 1104 of the cartridge 1008, and through the condensate output port 1106. Returning to FIG. 12, once through the condensate output port 1106 of the cartridge 1108, the condensate flows into a catch area 1208 before exiting through the condensate output 1010, which may be connected to a drain or the like.

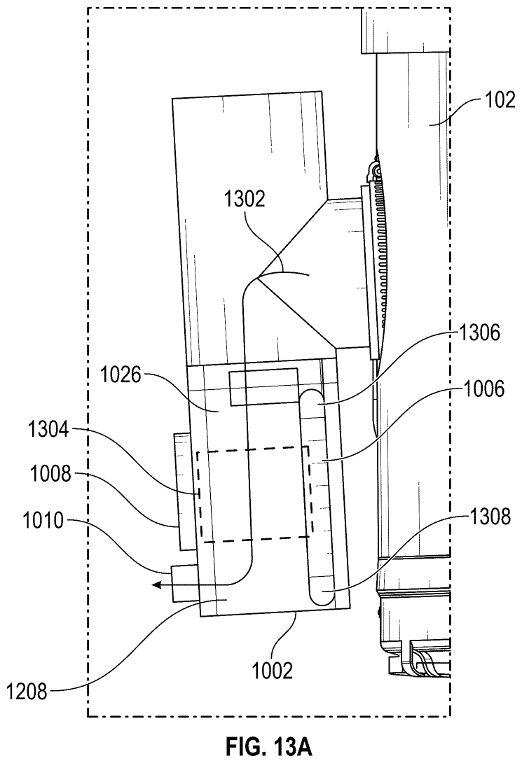

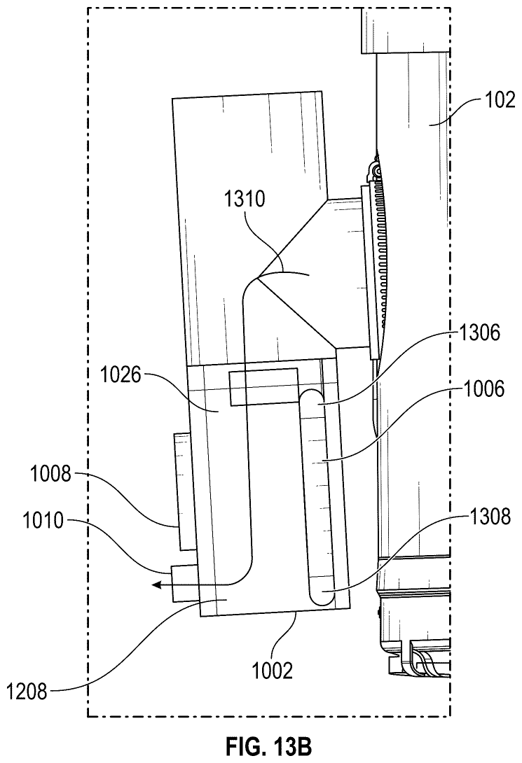

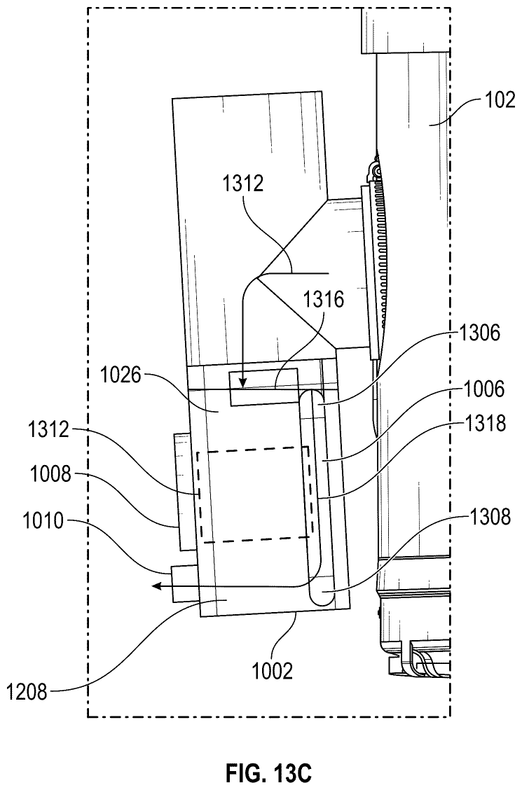

FIG. 13A illustrates a side view of the condensate management system 1000 with neutralizing material 1304 disposed therein. Arrow 1302 illustrates the flow of the condensate through the condensate management system 1000. The condensate neutralization material 1304 is represented as a dotted box. The overflow tubing 1006 includes a top connecting portion 1306 and a bottom connecting portion 1308. The top connecting portion 1306 corresponds to the overflow port 1027 illustrated in FIG. 10C. Accordingly, the overflow tubing 1006 connects the overflow space 1026 with the catch area 1208 by bypassing the condensate neutralization material 1304 within the cartridge 1008.

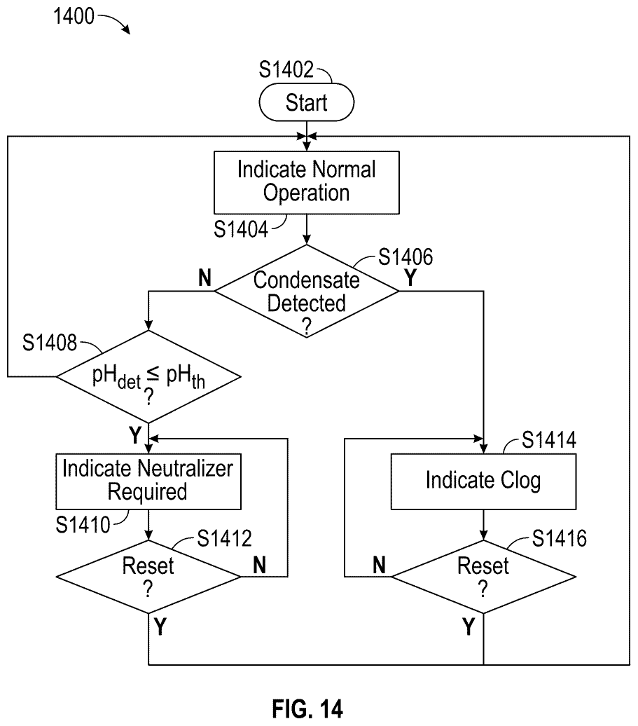

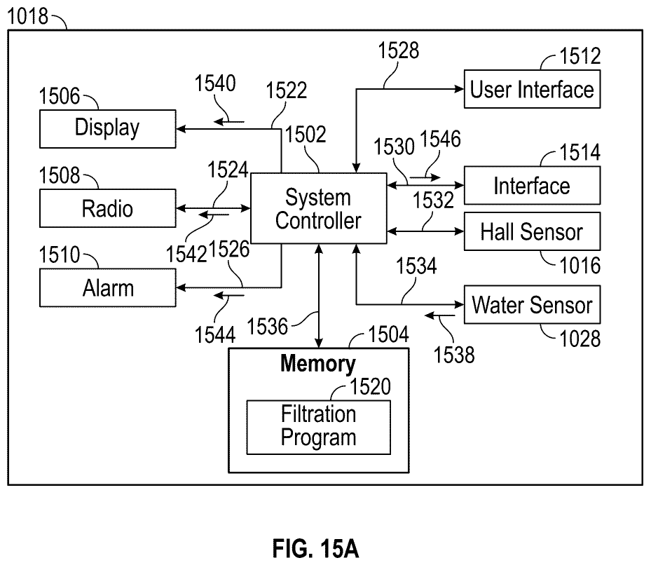

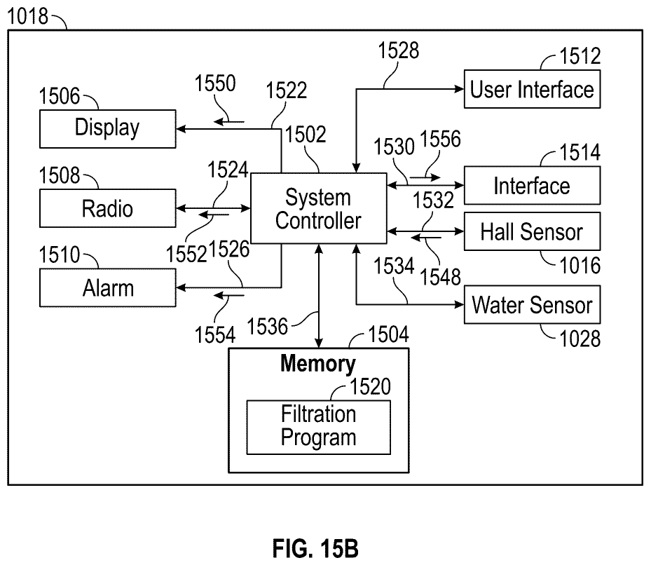

FIG. 14 illustrates a method 1400 of operating the condensate management system of FIG. 10A in accordance with one or more embodiments of the present disclosure. Method 1400 starts (S1402), and normal operation is indicated (S1404). This will be described in greater detail with reference to FIG. 15A.

FIG. 15A illustrates the controller 1018 of the condensate management system of FIG. 10A in accordance with one or more embodiments of the present disclosure at a time t2. The controller 1018 includes a system controller 1502, a memory 1504, a display 1506, a radio 1508, an alarm 1510, a user interface 1512, an interface 1514, a pH sensor 1016, and a water sensor 1028. The memory 1504 has data and instructions stored therein, including filtration program 1520.

The system controller 1502 is configured to communicate with the display 1506 via a communication channel 1522, the radio 1508 via a communication channel 1524, the alarm 1510 via a communication channel 1526, the user interface 1512 via a communication channel 1528, the interface 1514 via a communication channel 1530, the pH sensor 1016 via a communication channel 1532, the water sensor 1028 via a communication channel 1534, and the memory 1504 via a communication channel 1536.

In this example, the system controller 1502, the memory 1504, the display 1506, the radio 1508, the alarm 1510, the user interface 1512, the interface 1514, the pH sensor 1016, and the water sensor 1028 are illustrated as individual devices. However, in some embodiments, at least two of the system controller 1502, the memory 1504, the display 1506, the radio 1508, the alarm 1510, the user interface 1512, the interface 1514, the pH sensor 1016, and the water sensor 1028 may be combined as a unitary device.

The system controller 1502 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of the controller 1018 in accordance with the embodiments described in the present disclosure.

The memory 1504 may have instructions, including the filtration program 1520, stored therein to be executed by the system controller 1502, causing the controller 1018 to cause the alarm 1510 to provide a low pH indication based on a pH sensor signal from the pH sensor 1016. In some instances, the memory 1504 may have instructions, including the filtration program 1520, stored therein to be executed by the system controller 1502, causing the controller 1018 to cause the alarm 1510 to provide a clog indication based on a water detection signal from the water sensor 1028. In some instances, clogs can form due to the neutralizer pellets/media coalesce or from impurities forming and blocking the outlet.

The display 1506 may be any known device or system that is configured to display information related to the controller 1018 to a user.

The radio 1508 may include an interface radio transceiver that is configured to communicate a network. The alarm 1510 may be any known device or system that is configured to provide a localized pH warning in the form of an audible indication, a visual indication, and combinations thereof and to provide a localized sensed water warning in the form of an audible indication, a visual indication, and combinations thereof. In some instances, the audible indication may take the form of a constant tone, a periodic beep, or the like. In some instances, the visual indication may take the form of a constantly lighted diode, a blinking diode, or the like. In some instances, the localized pH warning is different from the localized sensed water warning. For example, the localized pH warning may take the form of a first audible indication, whereas the localized sensed water warning may take the form of a second audible indication that is different in either tone, volume or periodicity (e.g., constant or beeping) from that of the first audible indication. As another example, the localized pH warning may take the form of a first visual indication, whereas the localized sensed water warning may take the form of a second visual indication that is different in either color or periodicity (e.g., constant or blinking) from that of the first visual indication.

The user interface 1512 may be any known device or system to enable a user to interact with the controller 1018. The pH sensor 1016 may be any known device or system that is configured to detect a pH level of the condensate and to output a pH sensor signal based on the detected pH level of the condensate. In some instances, the pH sensor 1016 is configured to output a pH sensor signal in response to a ping from the system controller 1502. In some instances, the pH sensor 1016 is configured to output a pH sensor signal at a predetermined frequency, e.g., every 1, 2, 5 seconds etc. or every minute. Any suitable frequency may be used. In some instances, the pH sensor 1016 is configured to output a pH sensor signal when the detected pH of the condensate, pH_{det}, drops below a predetermined threshold pH level, pHₜₕ.

The water sensor 1028 may be any known device or system that is configured to detect the condensate and to output a water detection signal based on the detected condensate. In certain instances, the system controller 1502 may execute instructions in the filtration program 1520 to cause the display 1506 to indicate that the condensate management system 1000 is operating normally as a default. Such indication may take the form of an LED, a graphic user interface that explicitly displays words such as “Normal Operation,” a graphic user interface that illustrates some icon that corresponds to normal operation, or the like.

Returning to FIG. 14, after an indication of normal operation (S1404), it is determined whether condensate is detected (S1406). For example, as shown in FIG. 10C, if condensate backups up so as to flood the overflow space 1026, the water sensor 1028 will detect the condensate. As shown in FIG. 15A, if the water sensor 1028 senses water, the water sensor 1028 may transmit a water detection signal 1538 to the system controller 1502. Upon receiving the water detection signal 1538, the system controller 1502 may execute instructions in the filtration program 1520 to cause the system controller 1502 to determine that condensate is detected.

Returning to FIG. 14, if it is determined that condensate is not detected (N at S1406), it is then determined whether the detected pH of the condensate, pH_{det}, is less than or equal to a predetermined threshold pH, pHₜₕ (S1408). For example, as shown in FIG. 13B, if the condensate neutralizing material is totally depleted within the cartridge 1008, then the condensate from the water tank will flow through the cartridge 1008 without being neutralized and flow out the condensate output 1010, as indicated by the arrow 1310. However, the pH detector 1016 will detect the pH level of the condensate at the catch area 1208. In this instance, because there is no condensate neutralization material within the cartridge 1008, then the pH of the condensate within the catch area 1208 will be low, e.g., acidic. As shown in FIG. 15B, the pH sensor 1016 may then transmit a pH sensor signal 1548 to the system controller 1502 via the communication channel 1532, wherein the pH sensor signal 1548 includes a detected pH value, pH_{det}, of the condensate within the catch area 1208.

In certain embodiments, the memory 1504 may have a threshold value of pH, pHₜₕ, which corresponds to an indication that the condensate has not been sufficiently neutralized, which would indicate that there is insufficient condensate neutralization material within the cartridge 1008. The system controller 1502 may then execute instructions within the filtration program 1520 to obtain the threshold value of pH, pHₜₕ, from the memory 1504. The system controller 1502 may then execute instructions in the filtration program 1520 to determine whether the pH_{det}≤pHₜₕ.

Returning to FIG. 14, if it is determined that pH_{det} is not less than or equal to pHₜₕ (N at S1408), then the normal operation continues to be indicated (return to S1404). Alternatively, if it is determined that pH_{det} is less than or equal to pHₜₕ (Y at S1408), then an indication is provided that neutralizer material is required (S1410). For example, as shown in FIG. 15B, in one or more embodiments, the system controller 1502 may execute instructions in the filtration program 1520 to cause the system controller 1502 to transmit a display instruction 1550 to the display 1506 via the communication channel 1522. The display instruction 1550 may instruct the display 1506 to indicate that condensate neutralization material needs to be added to the condensate management system 1000 in a manner similar to that discussed above with reference to FIG. 8 (see S808).

In one or more embodiments, the system controller 1502 may execute instructions in the filtration program 1520 to cause the system controller 1502 to transmit an instruction 1552 to the radio 1508 via the communication channel 1524. The instruction 1552 may cause the radio 1508 to wirelessly communicate with an associated client device, such as a smartphone or tablet of the user in manner similar to that discussed above with reference to FIG. 8 (see S808). In one or more embodiments, the system controller 1502 may execute instructions in the filtration program 1520 to cause the system controller 1502 to transmit an alarm instruction 1554 to the alarm 1510 via the communication channel 1526. The alarm instruction 1554 may cause the alarm 1510 to provide a localized warning in the form of an audible indication, a visual indication, and combinations thereof. In one or more embodiments, the system controller 1502 may execute instructions in the filtration program 1520 to cause the system controller 1502 to transmit a network instruction 1556 to the interface 1514 via the communication channel 1530. The network instruction 1556 may cause the interface 1514 to communicate with a network device of the user, such as a desk-top computer, in a manner similar to that discussed above with reference to FIG. 8 (see S808). When a user is notified that condensate neutralization material is needed, by any of the display 1506, the radio 1508, the alarm 1510, the interface 1514, or combinations thereof, the user may replace the condensate neutralization material. For example, the user may replace the cartridge 1008 with a new cartridge that is filled with condensate neutralization material.

Returning to FIG. 14, after an indication is provided that neutralizer material is required (S1410), it is determined whether the system has been reset (S1412). This may be performed in a manner similar to that discussed with reference to FIG. 8 (see S810). Returning to FIG. 14, if it is determined that the system has not been reset (N at S1412), then the indication that neutralizer material is required remains (return to S1410). Alternatively, if it is determined that the system has been reset (Y at S1412), then an indication of normal operation is again provided (return to S1404).

If condensate is detected (S1406), then an indication is provided of a clog (S1414). For example, as shown in FIG. 13C, a clog 1312 in the cartridge 1008 prevents condensate 1314 from passing through the cartridge 1008. As such, the condensate 1314 backs up to a level indicated by line 1316. Returning to FIG. 10C, when the condensate fills into the overflow space 1026, it contacts the water sensor 1028. This triggers the water sensor 1028 to transmit the water detection signal 1538. Further, the condensate eventually fills within the overflow space 1026 to a point where the condensate flows out the overflow port 1027 and into the overflow tubing 1006. Returning to FIG. 13C, the condensate then flows through the overflow tubing 1006, as indicated by the arrow 1318, from the overflow space 1026 to the catch area 1208 and then out the condensate output 1010.

As shown in FIG. 15A, in one or more embodiments, upon receiving the water detection signal 1538, the system controller 1502 may execute instructions in the filtration program 1520 to cause the system controller 1502 to transmit a display instruction 1540 to the display 1506 via the communication channel 1522. The display instruction 1550 may instruct the display 1506 to indicate a blockage and that the cartridge 1008 should be replaced. The indication may be performed in a manner similar to that discussed above with reference to FIG. 8 (see S808).

In one or more embodiments, the system controller 1502 may execute instructions in the filtration program 1520 to cause the system controller 1502 to transmit an instruction 1542 to the radio 1508 via the communication channel 1524. The instruction 1542 may cause the radio 1508 to wirelessly communicate with an associated client device, such as a smartphone or tablet of the user in manner similar to that discussed above with reference to FIG. 8 (see S808). In one or more embodiments, the system controller 1502 may execute instructions in the filtration program 1520 to cause the system controller 1502 to transmit an alarm instruction 1544 to the alarm 1510 via the communication channel 1526. The alarm instruction 1544 may cause the alarm 1510 to provide a localized warning in the form of an audible indication, a visual indication, and combinations thereof. In one or more embodiments, the system controller 1502 may execute instructions in the filtration program 1520 to cause the system controller 1502 to transmit a network instruction 1546 to the interface 1514 via the communication channel 1530. The network instruction 1546 may cause the interface 1514 to communicate with a network device of the user, such as a desk-top computer in a manner similar to that discussed above with reference to FIG. 8 (see S808). When a user is notified of a blockage and that a new cartridge is needed, by any of the display 1506, the radio 1508, the alarm 1510, the interface 1514, or combinations thereof, the user may replace the cartridge 1008.

Returning to FIG. 14, after an indication is provided of a clog (S1414), it is determined whether the system has been reset (S1416). This may be performed in a manner similar to that discussed above (see S1412). Returning to FIG. 14, if it is determined that the system has not been reset (N at S1416), then the indication of a clog remains (return to S1414). Alternatively, if it is determined that the system has been reset (Y at S1416), then an indication of normal operation is again provided (return to S1404).

It should be apparent that the foregoing relates only to certain embodiments of the present disclosure and that numerous changes and modifications may be made herein by one of ordinary skill in the art without departing from the general spirit and scope of the disclosure.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system for use with a fuel-burning water heater and a ventilation conduit, the fuel-burning water heater being configured to burn fuel and generate gaseous exhaust and condensate from the burning of the fuel, the ventilation conduit being configured to remove the gaseous exhaust from the fuel-burning water heater, the system comprising:
an input port configured to receive the gaseous exhaust and the condensate;
a neutralizing material holder configured to house a condensate neutralizing material therein and to receive the condensate from the input port;
a gas output port configured to provide the gaseous exhaust to the ventilation conduit; and
a liquid output port configured to output condensate from the neutralizing material holder,
wherein the neutralizing material holder is disposed between the input port and the liquid output port.

2. The system of claim 1, further comprising:
a neutralizing material holder access port configured to enable placement of the condensate neutralizing material into the neutralizing material holder,
wherein the neutralizing material holder comprises a cartridge configured to be removably inserted into the neutralizing material holder access port.

3. The system of claim 2,
wherein the cartridge comprises an input cartridge port, an output cartridge port, and a space between the input cartridge port and the output cartridge port configured to retain the condensate neutralizing material,
wherein the input cartridge port is configured to receive the condensate from the input port, and
wherein the output cartridge port is configured to pass the condensate received at the input cartridge port to the liquid output port.

4. The system of claim 1, further comprising:
a neutralizing material holder access port configured to enable placement of the condensate neutralizing material into the neutralizing material holder; and
a moveable panel configured to be in an opened state or a closed state,
wherein in the opened state, the moveable panel is configured to provide access to the neutralizing material holder access port, and
wherein in the closed state, the moveable panel is configured to cover the neutralizing material holder access port.

5. The system of claim 1, further comprising:
a magnet within the neutralizing material holder; and
a Hall sensor configured to output a Hall sensor signal based on the magnet as a function of the amount of the condensate neutralizing material within neutralizing material holder.

6. The system of claim 5, further comprising:
a neutralizing material holder access port configured to enable placement of the condensate neutralizing material into the neutralizing material holder;
a moveable panel configured to be in an opened state or a closed state; and
a tether having a first end connected to the magnet and a second end connected to the moveable panel,
wherein in the opened state, the moveable panel is configured to provide access to the neutralizing material holder access port, and
wherein in the closed state, the moveable panel is configured to cover the neutralizing material holder access port.

7. The system of claim 5, further comprising:
an alarm configured to provide a low neutralizing material indication based on the Hall sensor signal,
wherein the low neutralizing material indication comprises one or more indications comprising an audible indication, a visual indication, or a combination thereof.

8. The system of claim 1, wherein the neutralizing material holder is configured to hold a single slab of the condensate neutralizing material.

9. The system of claim 1, further comprising:
a water sensor configured to output a water detection signal,
wherein the neutralizer material holder access port is disposed between the water sensor and the liquid output port.

10. The system of claim 1, further comprising a pH sensor configured to output a pH sensor signal based on the pH of the condensate at the liquid output port.

11. The system of claim 10, further comprising:
an alarm configured to provide a low pH indication based on the pH sensor signal,
wherein the low pH indication comprises one or more indications comprising an audible indication, a visual indication, or a combination thereof.

12. The system of claim 10, further comprising a radio configured to wirelessly transmit a low pH indication based on the pH sensor signal.

13. The system of claim 1, further comprising:
an overflow tube having an overflow tube input port and an overflow tube output port,
wherein the overflow tube is configured to permit a portion of the condensate to flow into the overflow tubing input port and out of the overflow tubing output port,
wherein the overflow tubing input port is disposed between the input port and the neutralizing material holder, and
wherein the overflow tubing output port is disposed between the neutralizing material holder and the liquid output port.

14. The system of claim 1, further comprising:
a first mesh screen disposed between the input port and the neutralizing material holder; and
a second mesh screen disposed between the liquid output port and the neutralizing material holder.

15. The system of claim 1, wherein the neutralizing material holder is detachably fastened to the input port and the liquid output port.

16. A water heater, comprising:
a condensate management system comprising:
an input port configured to receive a gaseous exhaust and condensate;
a neutralizing material holder configured to house a condensate neutralizing material therein and to receive the condensate from the input port;
a gas output port configured to provide the gaseous exhaust to the ventilation conduit; and
a liquid output port configured to output condensate from the neutralizing material holder,
wherein the neutralizing material holder is disposed between the input port and the liquid output port.

17. The water heater of claim 16, further comprising:
a neutralizing material holder access port configured to enable placement of the condensate neutralizing material into the neutralizing material holder,
wherein the neutralizing material holder comprises a cartridge configured to be removably inserted into the neutralizing material holder access port.

18. The water heater of claim 16, further comprising:
a neutralizing material holder access port configured to enable placement of the condensate neutralizing material into the neutralizing material holder; and
a moveable panel configured to be in an opened state or a closed state,
wherein in the opened state, the moveable panel is configured to provide access to the neutralizing material holder access port, and
wherein in the closed state, the moveable panel is configured to cover the neutralizing material holder access port.

19. The water heater of claim 16, further comprising:
a magnet within the neutralizing material holder; and
a Hall sensor configured to output a Hall sensor signal based on the magnet as a function of the amount of the condensate neutralizing material within neutralizing material holder.

20. A method of managing condensate of a water heater, the method comprising:
positioning a condensate management system about a gaseous exhaust and condensate outlet of the water heater;
receiving, by an input port of the condensate management system, gaseous exhaust and condensate from the gaseous exhaust and condensate outlet of the water heater;
receiving, by a neutralizing material holder of the condensate management system, the condensate from the input port, wherein the neutralizing material holder is configured to house a condensate neutralizing material therein;
passing the condensate through the condensate neutralizing material within neutralizing material holder;
outputting, by a liquid output port of the condensate management system, the condensate from the neutralizing material holder after the condensate has passed through the condensate neutralizing material; and
directing, by a gas output port of the condensate management system, the gaseous exhaust to a ventilation conduit;
wherein the neutralizing material holder is disposed between the input port and the liquid output port.
